(19) United States
(12) Patent Application Publication
(10) Pub. No.: US 2016/0275213 A1
(43) Pub. Date: Sep. 22, 2016

(54) BEHAVIORAL SYNTHESIS METHOD, BEHAVIORAL SYNTHESIS DEVICE AND COMPUTER READABLE RECORDING MEDIUM STORING BEHAVIORAL SYNTHESIS PROGRAM

(71) Applicant: FUJITSU LIMITED, Kawasaki-shi (JP)

(72) Inventor: Yoshinori Tomita, Yokohama (JP)

(73) Assignee: FUJITSU LIMITED, Kawasaki-shi (JP)

(21) Appl. No.: 14/990,292

(22) Filed: Jan. 7, 2016

(30) Foreign Application Priority Data
Mar. 19, 2015 (JP) 2015-056159

(51) Int. Cl. G06F 17/50

(52) U.S. Cl. CPC G06F 17/505

(57) ABSTRACT

A behavioral synthesis method includes: expanding, by a computer, loop processing included in a behavioral description; extracting a part at which same processing is executed from an expanded loop processing; transforming the behavioral description by turning the part to a function; and carrying out behavioral synthesis based on a transformed behavioral description.

### CROSS-REFERENCE TO RELATED APPLICATION

This application is based upon and claims the benefit of priority of the prior Japanese Patent Application No. 2015-056159, filed on Mar. 19, 2015, the entire contents of which are incorporated herein by reference.

### FIELD

The embodiments disclosed herein are related to a behavioral synthesis method, a behavioral synthesis device and a computer readable recording medium storing a behavioral synthesis program.

### BACKGROUND

A logic circuit is synthesized by a computer.

A related art is disclosed in Japanese Laid-open Patent Publication No. 08-44773.

### SUMMARY

According to an aspect of the embodiments, a behavioral synthesis method includes: expanding, by a computer, loop processing included in a behavioral description; extracting a part at which isomorphic processing is executed from an expanded loop processing; transforming the behavioral description by turning the part to a function; and carrying out behavioral synthesis based on a transformed behavioral description.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of behavioral descriptions;

FIG. 2 illustrates one example of analysis results of variables;

FIG. 3 illustrates one example of a functional configuration of a behavioral synthesis device;

FIG. 4 illustrates one example of operation of a behavioral synthesis device;

FIG. 5 illustrates one example of preprocessing;

FIG. 6 illustrates one example of loop expanding;

FIG. 7 illustrates one example of optimization;

FIG. 8 illustrates one example of name change of variables;

FIG. 9 illustrates one example of construction of a dependency relationship graph;

FIG. 10 illustrates one example of a subgraph;

FIG. 11 illustrates one example of turning to a function;

FIG. 12 illustrates one example of a behavioral description after preprocessing;

FIG. 13 illustrates one example of a circuit by high-level synthesis;

FIG. 14 illustrates one example of a circuit block;

FIG. 15 illustrates one example of a circuit by high-level synthesis;

FIG. 16 illustrates one example of a behavioral description;

FIG. 17 illustrates one example of a behavioral description after preprocessing; and

FIG. 18 illustrates one example of a hardware configuration of a computer.

### DESCRIPTION OF EMBODIMENT

For example, a behavioral description in which an algorithm to be processed by a logic circuit is described by a program language such as the C language is transformed to a circuit description of the register transfer level (RTL) such as the Verilog-hardware description language (HDL) or the very high speed integrated circuit hardware description language (VHDL) and is subjected to behavioral synthesis (high-level synthesis).

For example, depending on the contents of the behavioral description, the circuit description of a circuit that executes efficient processing might not be obtained.

For example, in algorithms of two behavioral descriptions that are not different from each other in terms of algorithm, equal output data is returned in response to input data. When behavioral synthesis is carried out about these two behavioral descriptions, circuit descriptions of circuits different from each other in the processing efficiency might be generated.

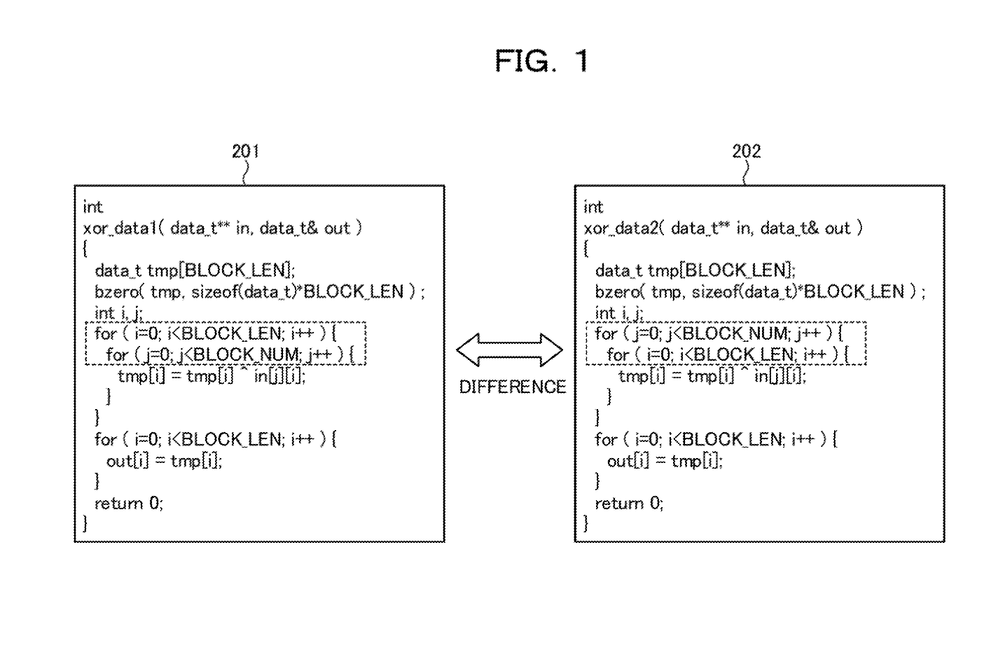

FIG. 1 illustrates one example of behavioral descriptions. As illustrated in FIG. 1, in behavioral descriptions 201 and 202, an algorithm in which XOR (exclusive logical sum) is performed on input data and output data is returned is described. In each of the behavioral descriptions 201 and 202, XOR is performed on input data and equal output data is returned. However, the behavioral descriptions 201 and 202 have a difference in a multiloop structure in the algorithm. Due to this difference, when the behavioral descriptions 201 and 202 are behaviorally synthesized and circuit descriptions are generated, circuits based on these circuit descriptions might be different from each other.

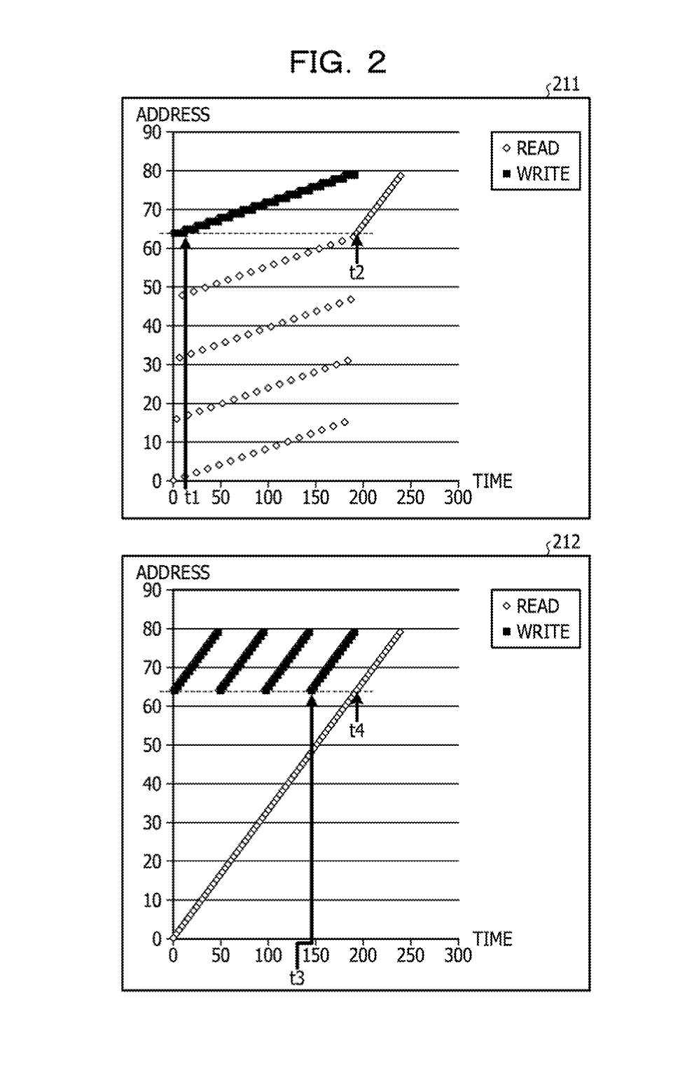

FIG. 2 illustrates one example of analysis results of variables. For example, in FIG. 2, analysis results 211 and 212 as the lifetime of variables obtained by executing software processing about the behavioral descriptions 201 and 202 illustrated in FIG. 1 are illustrated. Major variables about which the analysis of the lifetime is carried out are in[j][i] and tmp[i] (out[i] is omitted because being obtained by only assigning tmp[i]). The variable in[j][i] is allocated to addresses 0 to 63 and the variable tmp[i] is allocated to address 64 and the subsequent addresses.

The analysis result 211 illustrates a graph representing the lifetime of the variables when processing of the behavioral description 201 is executed. The analysis result 212 illustrates a graph representing the lifetime of the variables when processing of the behavioral description 202 is executed. Times t1 and t3 are times when out[0], which is the first output data, is settled. Times t2 and t4 are times when out[0] is output.

As illustrated in FIG. 2, the time t1 when out[0] as the first output data is settled is 11 in the analysis result 211, whereas the time t3 when out[0] is settled is 146 in the analysis result 212. In the analysis results 211 and 212, the output of out[0] (time t2 and t4) is not immediately after the settlement of out[0]. However, the output of out[0] may be carried out at any time as long as the output is after the settlement of out[0]. Therefore, in input/output (I/O) scheduling in which out[0] is output immediately after being settled, resources relating to out[0] may be opened after out[0] is output. Data to be treated in the next processing is stored in the opened resources and advanced execution by pipeline processing is enabled.

When the analysis results 211 and 212 are compared, the time when the advanced execution by pipeline processing is enabled is 11 of the time t1 in the analysis result 211, and is 146 of the time t3 in the analysis result 212. As a result, the advanced execution by pipeline processing can be carried out earlier in the analysis result 211 than in the analysis result 212. Therefore, from the behavioral description 201, which yields the analysis result 211, a circuit description of a circuit that executes efficient processing in which the speed of processing on input data is high and the throughput is high is generated.

In the following, a configuration having substantially the same function might be given the same numeral and overlapping explanation might be omitted or reduced.

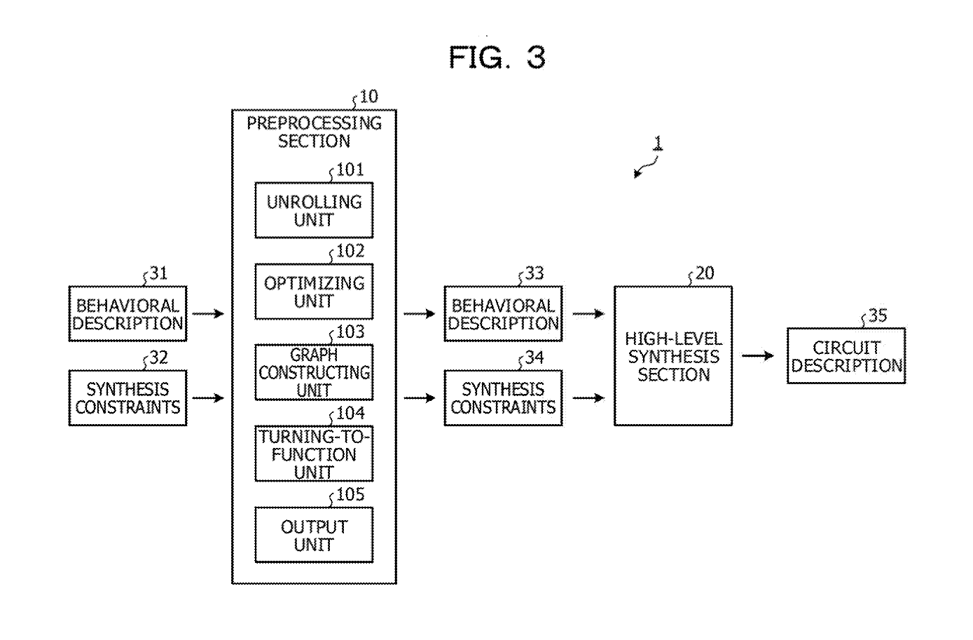

FIG. 3 illustrates one example of a functional configuration of a behavioral synthesis device. As illustrated in FIG. 3, a behavioral synthesis device 1 includes a preprocessing section 10 and a high-level synthesis section 20. The preprocessing section 10 executes preprocessing on a behavioral description 31 and synthesis constraints 32 that are input prior to behavioral synthesis (high-level synthesis).

In the behavioral description 31, functions of a logic circuit are described without awareness of a clock signal. For example, an algorithm to be processed by the logic circuit is described by a program language such as the C language. In the synthesis constraints 32, conditions imposed when behavioral synthesis is carried out are described. For example, in the synthesis constraints 32, operating conditions of a circuit (in terms of hardware) based on a circuit description 35 generated by behavioral synthesis, such as a circuit that operates at a clock frequency of 100 MHz, are cited.

The high-level synthesis section 20 carries out behavioral synthesis based on a behavioral description 33 and synthesis constraints 34 resulting from the preprocessing by the preprocessing section 10, and generates and outputs the circuit description 35 of the RTL in which functions between registers of the logic circuit are described based on the clock frequency employed as the operating condition.

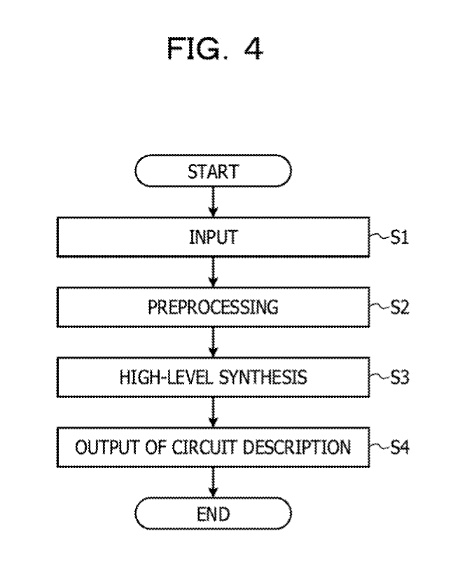

FIG. 4 illustrates one example of operation of a behavioral synthesis device. As illustrated in FIG. 4, when processing is started, the preprocessing section 10 accepts input of the behavioral description 31 and the synthesis constraints 32 through operation of a console and reading of data stored in a storage in advance (S1). The preprocessing section 10 executes preprocessing on the input behavioral description 31 and synthesis constraints 32 and outputs the behavioral description 33 and the synthesis constraints 34 (S2). The high-level synthesis section 20 carries out high-level synthesis (behavioral synthesis) based on the behavioral description 33 and the synthesis constraints 34 (S3) and outputs the circuit description 35 (S4).

The preprocessing section 10 includes an unrolling unit 101, an optimizing unit 102, a graph constructing unit 103, a turning-to-function unit 104, and an output unit 105.

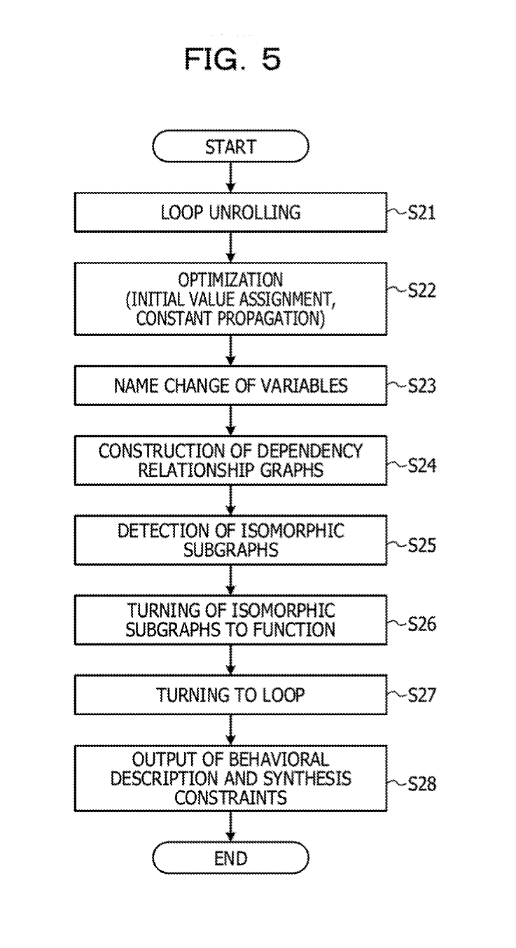

FIG. 5 illustrates one example of preprocessing. As illustrated in FIG. 5, the unrolling unit 101 carries out parsing about the behavioral description 31 and expands loop processing included in the behavioral description 31 (S21). For example, the unrolling unit 101 generates a description in which loop variables of the loop processing repeated in the behavioral description 31 are replaced by actual numerical values and are cited.

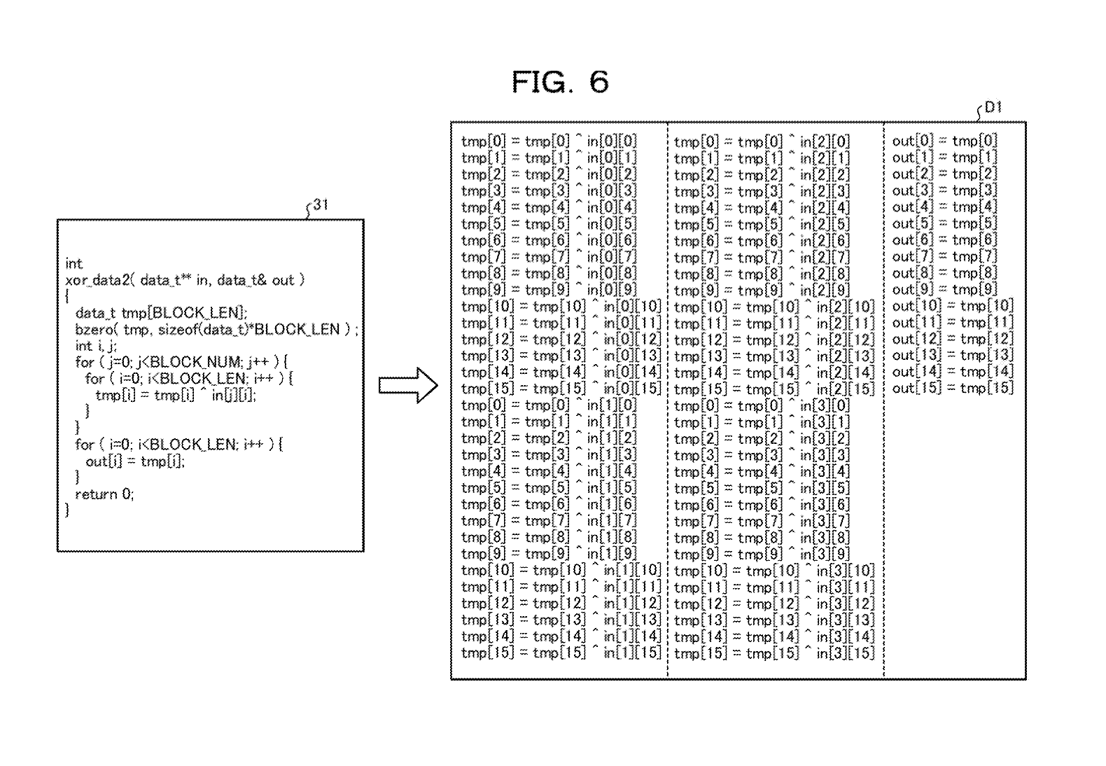

FIG. 6 illustrates one example of loop unrolling. As illustrated in FIG. 6, the unrolling unit 101 generates data D1 obtained by expanding the loop processing of a for sentence included in the behavioral description 31. For example, regarding the loop processing, a case in which the loop processing is expanded with a condition of BLOCK_LEN=16 and BLOCK_NUM=4 is illustrated. In FIG. 6, the data D1 obtained by extracting the description part at which the loop processing is expanded in the behavioral description 31 is illustrated.

Subsequently to S21, the optimizing unit 102 carries out optimization (initial value assignment, constant propagation) in accordance with a rule set in advance regarding the description resulting from the expanding of the loop processing by the unrolling unit 101 (S22).

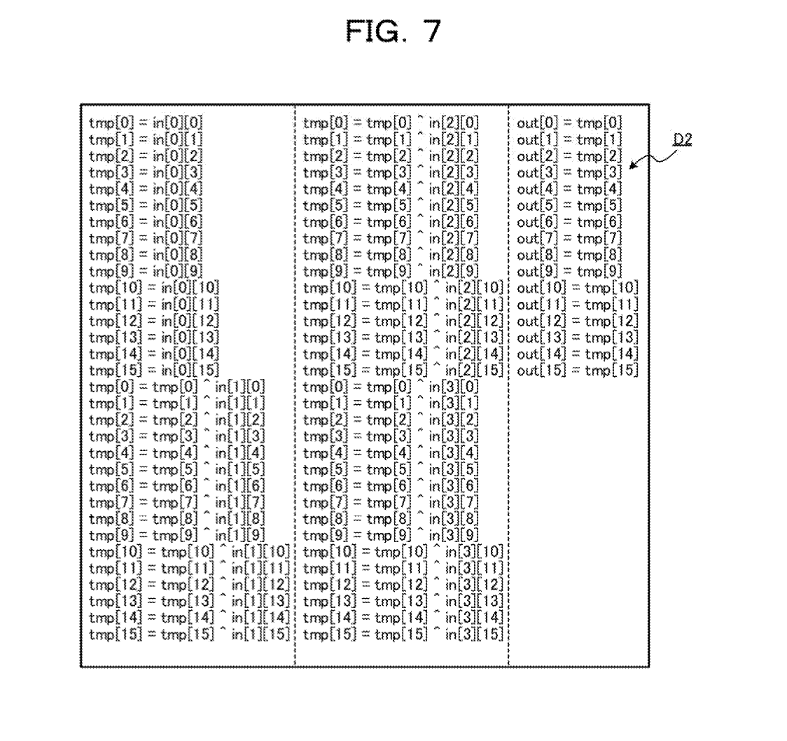

FIG. 7 illustrates one example of optimization. In FIG. 7, data D2 resulting from the optimization about the data D1 is illustrated. For example, as illustrated in FIG. 7, the optimizing unit 102 assigns an initial value to a variable included in the description of the data D1 to generate the data D2 whose description is optimized. For example, the optimizing unit 102 generates the data D2 whose description is simplified by utilizing that the initial value of tmp[ ] in the data D1 is 0.

Subsequently to S22, the graph constructing unit 103 constructs a tree-structure graph representing the dependency relationship of the loop processing based on the description resulting from the optimization by the optimizing unit 102. For example, the graph constructing unit 103 changes the names of variables appearing in the left-hand side and the right-hand side so that the dependency relationship in the processing can be traced regarding variables included in the description (S23).

For example, in semantics of a program language, the value of the variable in the left-hand side changes by assignment. If variables of the same name appear in the left-hand side and the right-hand side in a certain syntax, an implicit dependency relationship, for example, execution order, exists. Therefore, regarding the description after the loop processing is unrolled, the graph constructing unit 103 changes the variables in the left-hand side and the right-hand side as appropriate so that the dependency relationship can be determined from the literal characters even when order of program code sentences are rearranged later.

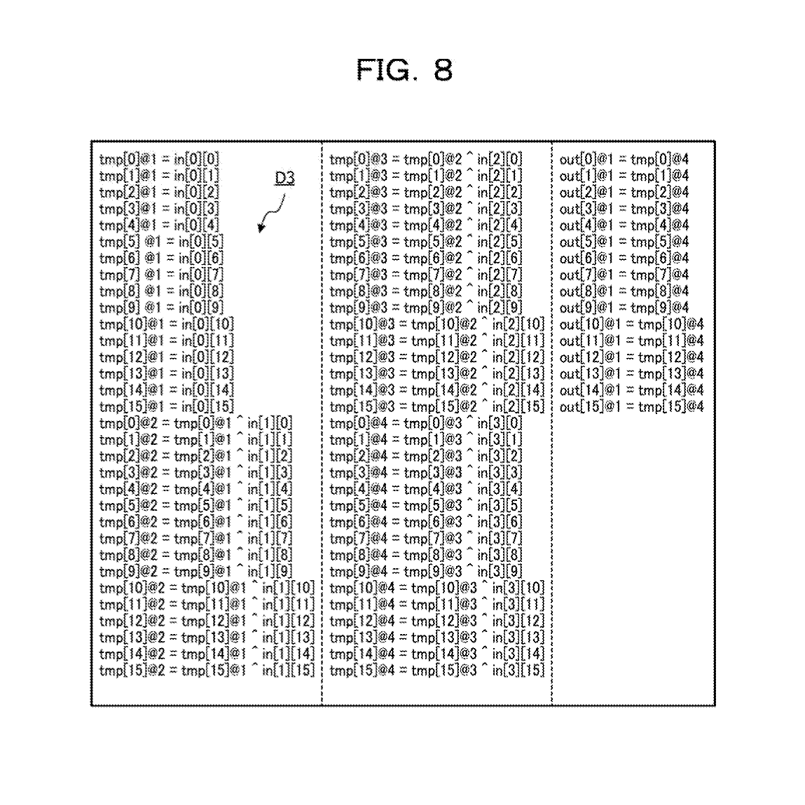

FIG. 8 illustrates one example of name change of variables. In FIG. 8, data D3 in which the names of variables are changed regarding the data D2 illustrated in FIG. 7 is illustrated. As illustrated in FIG. 8, the graph constructing unit 103 sequentially gives “@1,” “@2” . . . to the names of variables appearing in the left-hand side and the right-hand side in order of execution of the processing and thereby changes the names of the variables so that the dependency relationship of the variables can be determined.

For example, regarding tmp[0] that first appears in the left-hand side, the name is changed to tmp[0]@1. When tmp[0] appears next in the left-hand side, tmp[0] in the left-hand side is changed to tmp[0]@2. When tmp[0] appears in the right-hand side after tmp[0], which will be changed to tmp[0]@1, appears in the left-hand side, tmp[0] in the right-hand side is changed to tmp[0]@1.

Subsequently to S23, the graph constructing unit 103 constructs dependency relationship graphs representing the dependency relationship of the processing in a tree-structure manner based on the data D3, in which the names of variables are changed so that the dependency relationship can be determined (S24).

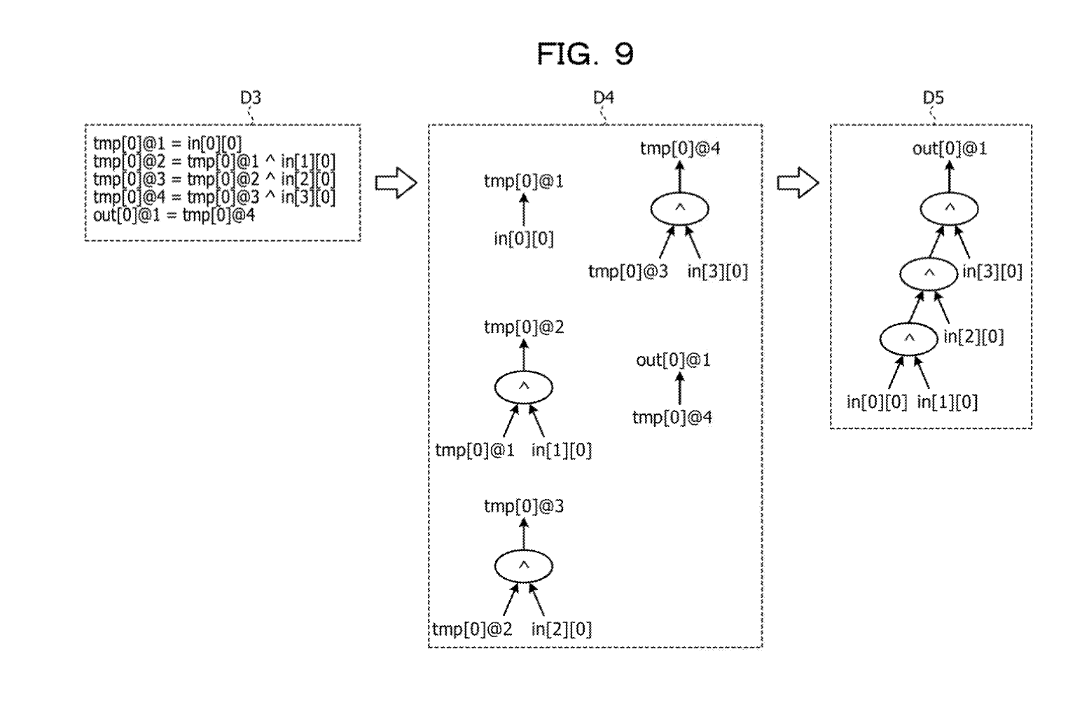

FIG. 9 illustrates one example of construction of a dependency relationship graph. As illustrated in FIG. 9, the graph constructing unit 103 expresses the dependency relationship of the processing by branches regarding each processing in the data D3. Based on data D4 in which variables and operations are expressed by nodes, the graph constructing unit 103 links nodes of the same name to create data D5 representing a dependency relationship graph.

For example, the graph constructing unit 103 selects an output variable (in the illustrated example, out[0]@1) as the root node. The graph constructing unit 103 links a node coupled to the root node, e.g. a node of the same name as tmp[0]@4. Subsequently, nodes of the same name are sequentially linked and paths that are not calculated are directly connected (node elimination). Thus, the data D5 is created. Although one output variable (out[0]@1) in the data D3 is represented in FIG. 9, dependency relationship graphs are similarly created also regarding other output variables (out[1]@1 to out[15]@1).

Subsequently to S24, the turning-to-function unit 104 detects isomorphic subgraphs from the constructed dependency relationship graphs (data D5) (S25). The isomorphic subgraph is a graph indicating that the contents of processing, e.g. the contents of operation, are same although name of variables and so forth are different in some cases in the dependency relationship graph. For example, a part corresponding to same operation processing that is repeatedly called and used in the loop processing included in the behavioral description 31 may be detected as the isomorphic subgraph. As above, “same processing corresponding to an isomorphic subgraph” may include processing in which constant values and the contents of operation are identical and processing in which the contents of operation and so forth are same although concrete name of variables are different.

For example, regarding the dependency relationship graph, the turning-to-function unit 104 turns node names equivalent to input variables and output variables to parameters, e.g. replaces concrete variable names by meaningless dummy argument names. Based on the graph resulting from parameter replacement, the graph is compared and checked whether or not it has an isomorphic graph.

For example, naming conventions in the turning of node names to parameters may be as follows: “@1” is deleted if the dependency relationship is not broken even when “@1” is deleted (what appears only one time may be deleted); a prefix “out” is added to output variables; a prefix “in” is added to input variables; the original node names are rearranged in lexicographic order both in the output variables and in the input variables and serial numbers are allocated as a suffix.

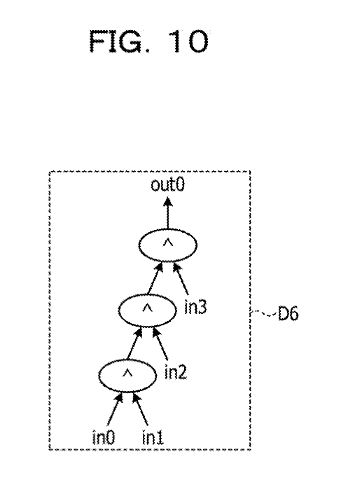

FIG. 10 illustrates one example of a subgraph. In FIG. 10, data D6 of the subgraph detected due to the data D5 illustrated in FIG. 9 is illustrated. For example, a subgraph like that illustrated in FIG. 10 is detected due to the dependency relationship graph resulting from turning to parameters in accordance with the above-described naming conventions. For example, sixteen subgraphs corresponding to sixteen output variables (out[0]@1 to out[15]@1) are detected.

Subsequently to S25, the turning-to-function unit 104 turns the detected isomorphic subgraphs to a function (S26). For example, the turning-to-function unit 104 transforms the contents of operation corresponding to the isomorphic subgraphs to a function description. The isomorphic subgraphs may be a function of the same name.

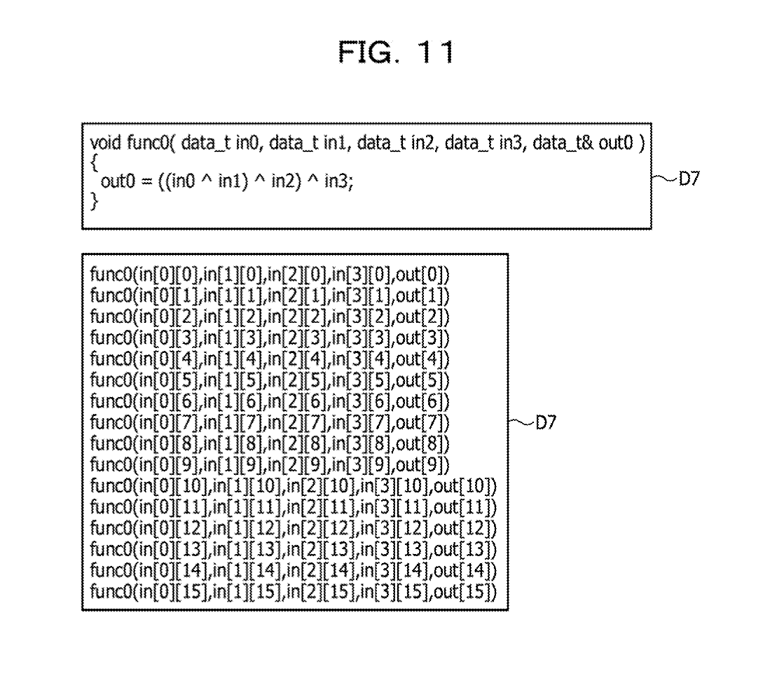

FIG. 11 illustrates one example of turning to a function. In FIG. 11, data D7 that is a description obtained by turning the subgraph in the data D6 illustrated in FIG. 10 to a function is illustrated. As illustrated in FIG. 11, the turning-to-function unit 104 transforms the subgraph in the data D6 to the data D7 in which inputs are in0 to in3 and output is out0 and the contents of operation are out0=((in0̂in1)̂in2)̂in3. The above-described contents of operation are turned to a function with a function name of “func0.” The sixteen subgraphs corresponding to the sixteen output variables (out[0]@1 to out[15]@1) are transformed to sixteen “func0.”

Subsequently to S26, the turning-to-function unit 104 carries out turning to a loop, i.e. replaces a repetition part in the description turned to the function by loop processing (S27). For example, the turning-to-function unit 104 detects a part that can be replaced by loop variables in the description turned to the function in S26 and reassembles the part to the loop processing. For example, in the case of the data D7 in FIG. 11, the function of func0 is repeated. Thus, turning to a loop through replacing by loop processing of a for sentence is carried out. By carrying out the turning to a loop as described above, the logic circuit of the circuit description 35 generated when behavioral synthesis is carried out in the high-level synthesis section 20 might be made more compact.

Subsequently to S27, the output unit 105 outputs the behavioral description 33 resulting from the turning to the loop due to S27. The output unit 105 outputs the synthesis constraints 34 obtained by adding, to the input synthesis constraints 32, a condition that restricts the function created from the subgraph by the turning to the function in S26 from being inline-expanded in the behavioral synthesis (S28).

For example, the output unit 105 outputs the synthesis constraints 34 to which a flag is given to restrict the function with the function name of “func0” by the turning to the function from being inline-expanded. Due to this, the high-level synthesis section 20 carries out behavioral synthesis based on the condition added to the synthesis constraints 34 to thereby treat the function part created from the subgraph as a single module and carry out pipeline synthesis of the function part. By carrying out the pipeline synthesis of the function part created from the subgraph in this manner, the throughput of the circuit might be improved.

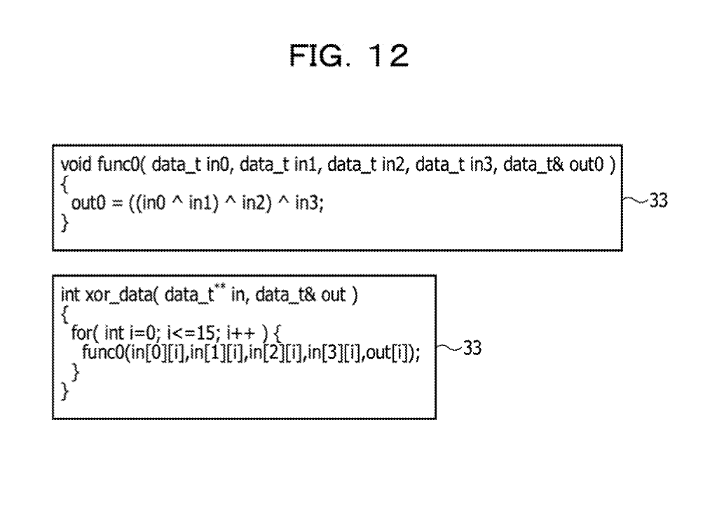

FIG. 12 illustrates one example of a behavioral description after preprocessing. In FIG. 12, the behavioral description 33 after the repetition part in the data D7 illustrated in FIG. 11 is turned to a loop is illustrated. According to comparison between the behavioral description 31 illustrated in FIG. 6 and the behavioral description 33 illustrated in FIG. 12, in the behavioral description 33, the loop processing included in the behavioral description 31 is expanded and then the part at which same processing is executed is turned to a function.

For example, when behavioral synthesis is carried out in the high-level synthesis section 20, in whole expanding of loop processing, the N part in the complexity order (O(N̂2) or O(N·log(N)) or the like) might increase in the scheduling allocation algorithm and a computational explosion might occur. The processing time might be extended and optimization in the behavioral synthesis might be insufficient, so that a circuit description of a circuit with low efficiency might be generated. In this case, a circuit description with a large latency number and a deep pipeline might be generated and the circuit might become very large.

In the behavioral synthesis device 1, as preprocessing of behavioral synthesis in the high-level synthesis section 20, loop processing included in the input behavioral description 31 is expanded and a part at which same processing is executed is turned to a function. Therefore, the N part in the complexity order might be reduced and the occurrence of a computational explosion might also be reduced. Because the part at which isomorphic processing is executed is turned to a function after the loop processing is expanded, a circuit description of a circuit in which the latency number of the circuit is small, the period for which data is carried inside is short and the processing efficiency is high might be obtained. For example, the buffer memory capacity for the circuit might be reduced and a circuit description of a circuit that efficiently executes streaming processing might be obtained.

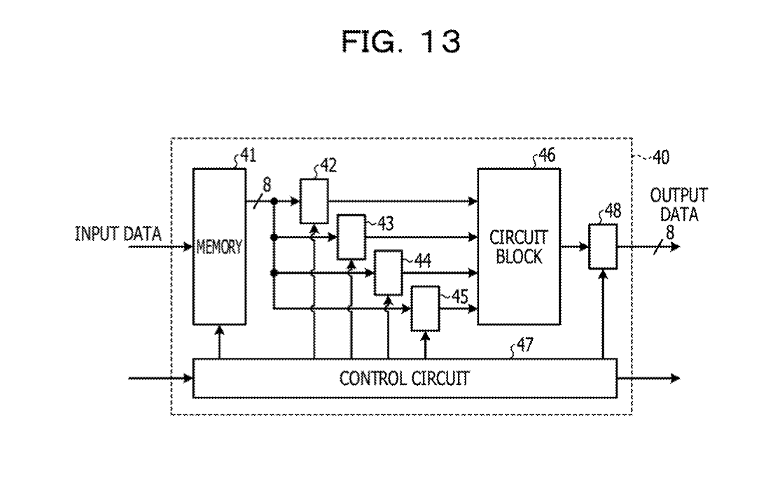

FIG. 13 illustrates one example of a circuit by high-level synthesis. In FIG. 13, a circuit 40 when the behavioral description 33 illustrated in FIG. 12 is behaviorally synthesized is illustrated. As illustrated in FIG. 13, the circuit 40 includes a memory 41, registers 42, 43, 44, 45, and 48, a circuit block 46, and a control circuit 47, and executes XOR processing on input data and outputs output data. The bit width of the data treated by the circuit 40 may be 8 bits.

The memory 41 stores input data and outputs the stored input data to the registers 42 to 45. The circuit block 46 accepts input from the registers 42 to 45 and executes processing corresponding to the function part of func0 in the behavioral description 33.

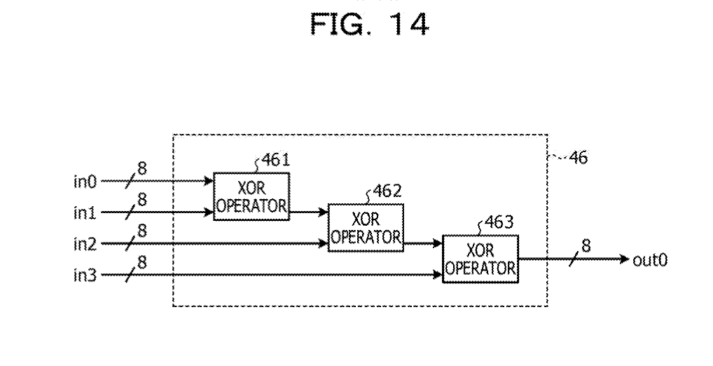

FIG. 14 illustrates one example of a circuit block. The circuit block illustrated in FIG. 14 may be the circuit block 46 illustrated in FIG. 13. As illustrated in FIG. 14, the circuit block 46 includes XOR operators 461 to 463 that perform XOR operation corresponding to the function part of func0 in the behavioral description 33 about data from the registers 42 to 45 (in0 to in3). The circuit block 46 outputs the operation result as out0.

The control circuit 47 controls the operation of the circuit 40. A signal line coupled to the control circuit 47 from the external is used to adjust timing such as when input data is stored in the memory 41 and when data stored in the register 48 is to be output between the circuit 40 and the external. The register 48 stores the operation result of the circuit block 46 (out0) and outputs the stored data due to an instruction from the control circuit 47.

The circuit 40 operates under control by the control circuit 47. For example, input data is stored in the memory 41 in the circuit 40. The control circuit 47 specifies a reading address to the memory 41 and stores data read out from the memory 41 in the registers 42 to 45. The control circuit 47 executes the above-described processing a total of four times about each of the four registers 42 to 45. The circuit block 46 reads out the data stored in the registers 42 to 45 and performs operation to store the operation result in the register 48. The control circuit 47 notifies the external of that the data stored in the register 48 (out0) has become valid. The control circuit 47 may repeat the above-described processing sixteen times for example.

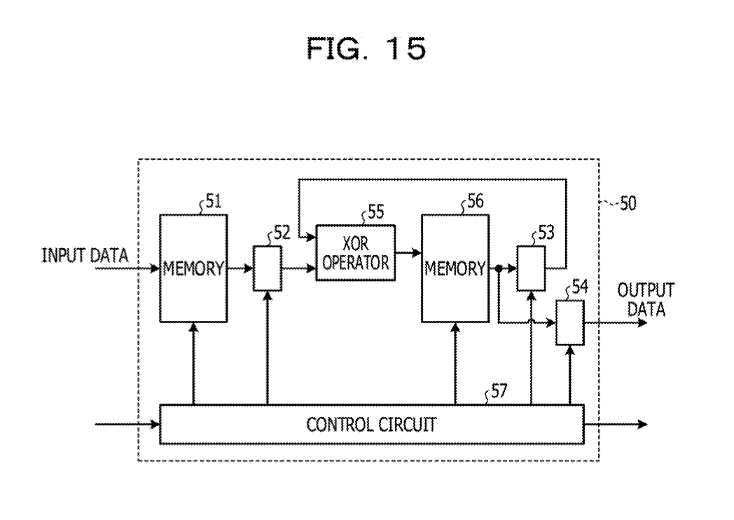

FIG. 15 illustrates one example of a circuit by high-level synthesis. In FIG. 15, a circuit 50 when the behavioral description 202 illustrated in FIG. 1 is behaviorally synthesized without being subjected to preprocessing is illustrated. As illustrated in FIG. 15, the circuit 50 includes memories 51 and 56, registers 52, 53, and 54, an XOR operator 55, and a control circuit 57. As with the circuit 40, the bit width of data treated by the circuit 50 may be 8 bits.

In the circuit 50, input data is stored in the memory 51. The control circuit 57 specifies reading addresses to the memories 51 and 56 and stores read data in the registers 52 to 54. The XOR operator 55 writes a result of operation on the data in the registers 52 and 53 to the memory 56. For example, the circuit 50 may repeat the above-described processing 4*16=64 times.

The control circuit 57 specifies a reading address to the memory 56 and stores read data in the register 54. The control circuit 57 notifies the external of that the data stored in the register 54 has become valid. The timing at which out0 as the first output data becomes valid and is settled may be the time t4 in the analysis result 212 illustrated in FIG. 2. For example, the control circuit 57 may repeat the above-described processing sixteen times.

An analysis result of variables when the operation of the circuit 40 is analyzed may be similar to the analysis result 211 illustrated in FIG. 2. For example, the timing at which the data stored in the register 48 becomes valid, e.g., the timing when out0 as the first output data is settled, may be almost the same value as the time t1 (11). According to comparison between the circuit 40 and the circuit 50, in the behavioral synthesis device 1, the circuit description 35 of a circuit that executes efficient processing might be obtained due to application of preprocessing on the input behavioral description 31 by the preprocessing section 10.

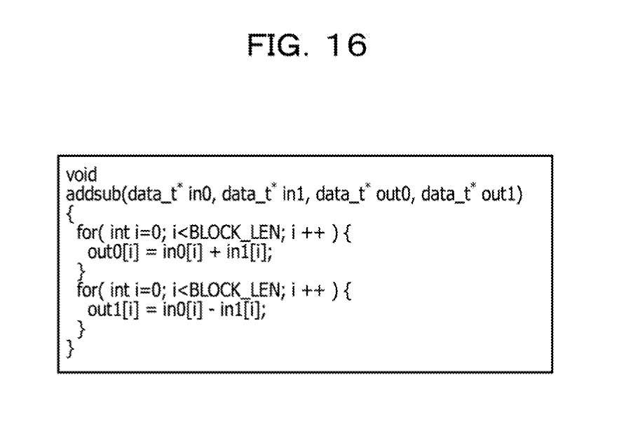

The loop processing included in the behavioral description 31 may include a configuration other than a multi-loop, in which a loop is included in a loop. FIG. 16 illustrates one example of a behavioral description. As illustrated in FIG. 16, the loop processing included in the behavioral description may be processing in which simply loop processing is successively included.

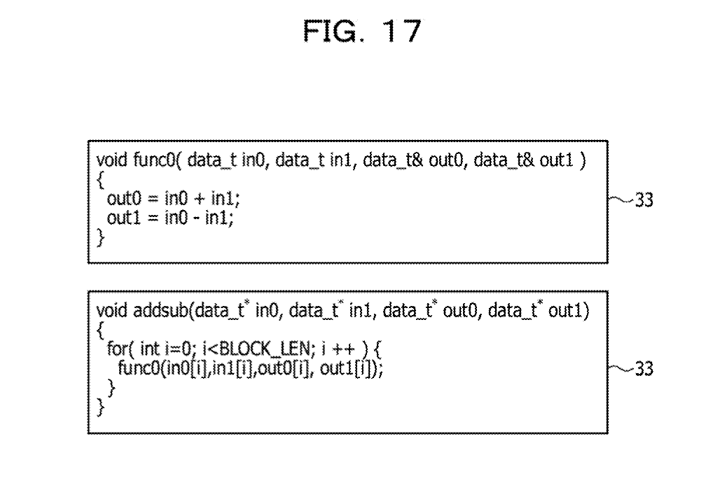

FIG. 17 illustrates one example of a behavioral description after preprocessing. In FIG. 17, the behavioral description 33 after the behavioral description illustrated in FIG. 16 is subjected to preprocessing is illustrated. As illustrated in FIG. 17, also regarding the behavioral description in which simply loop processing is successively included, the behavioral description 33 in which the loop processing is expanded and then a part at which same processing is executed is turned to a function might be obtained.

In the input behavioral description 31, the preprocessing section 10 of the behavioral synthesis device 1 expands loop processing included in the behavioral description 31 and extracts a part at which same processing is executed from the expanded loop processing to turn the extracted part to a function. The high-level synthesis section 20 of the behavioral synthesis device 1 carries out behavioral synthesis based on the behavioral description 33 resulting from the preprocessing by the preprocessing section 10. In the behavioral synthesis device 1, the part at which same processing is executed is turned to a function after the loop processing in the behavioral description 31 is expanded. Therefore, the circuit description 35 of a circuit in which the latency number of the circuit is small, the period for which data is carried inside is short and the processing efficiency is high might be obtained.

All or part of the above-described processing may be automatically executed or may be manually executed. The above-described processing procedure, concrete names, information including various kinds of data or parameters may be arbitrarily changed unless particularly noted.

All or part of the respective constituent elements of the device illustrated in the drawings may be distributed and integrated functionally or physically in arbitrary unit according to various kinds of loads, the state of use, and so forth.

All or an arbitrary part of the respective processing functions carried out in the device may be implemented by a central processing unit (CPU) and a program analyzed and executed by this CPU, or may be implemented as hardware based on wired logic.

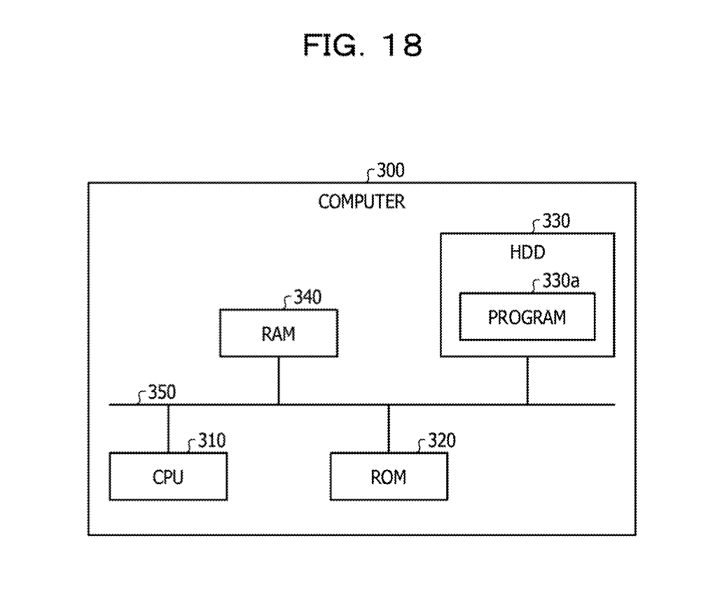

FIG. 18 illustrates one example of a hardware configuration of a computer. In FIG. 18, the hardware configuration of a computer 300 that operates as the behavioral synthesis device 1 is illustrated. As illustrated in FIG. 18, the computer 300 includes a CPU 310 that executes various kinds of operation processing, a read only memory (ROM) 320, a hard disk drive (HDD) 330, and a random access memory (RAM) 340. The respective devices 310 to 340 are coupled by a bus 350.

The HDD 330 stores a program 330a that causes the computer 300 to execute processing similar to processing of the preprocessing section 10 and the high-level synthesis section 20. The CPU 310 executes various kinds of processing by reading out the program 330a stored in the HDD 330 and expanding the program 330a in the RAM 340 to execute the program 330a.

The program 330a may be stored in the HDD 330. For example, the program 330a stored in a storage medium that can be read by the computer 300 may be read out and executed by the computer 300. The storage medium that can be read by the computer 300 may include e.g. a portable recording medium such as a compact disc (CD)-ROM, a digital versatile disc (DVD), and a universal serial bus (USB) memory, a semiconductor memory such as a flash memory, a hard disk drive, and so forth. Devices coupled to a public line, the Internet, a local area network (LAN), or the like may store the program 330a and the computer 300 may read out and execute the program 330a from the devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A behavioral synthesis method comprising:
expanding, by a computer, loop processing included in a behavioral description;
extracting a part at which same processing is executed from an expanded loop processing;
transforming the behavioral description by turning the part to a function; and
carrying out behavioral synthesis based on a transformed behavioral description.

2. The behavioral synthesis method according to claim 1,
wherein, in the extracting,
a tree-structure graph representing a dependency relationship of operations obtained from expanded the loop processing is constructed, and
an isomorphic subgraph is extracted from the tree-structure graph.

3. The behavioral synthesis method according to claim 2,
wherein, in the transforming,
processing of the subgraph is turned to the function to transform the behavioral description.

4. The behavioral synthesis method according to claim 1,
wherein, in the transforming,
constraint information that constrains the part turned to the function from being expanded in the behavioral synthesis is output, and
the behavioral synthesis is carried out based on the constraint information.

5. The behavioral synthesis method according to claim 1,
wherein a repetition part included in the part turned to the function is replaced by loop processing to transform the behavioral description.

6. A behavioral synthesis device comprising:
a processor configured to execute a program; and
a memory configured to store the program,
wherein, based on the program, the processor configured to:
expand loop processing included in a behavioral description;
extract a part at which same processing is executed from the expanded loop processing;
transforms the behavioral description by turning the part to a function; and
carries out behavioral synthesis based on the transformed behavioral description.

7. The behavioral synthesis device according to claim 6,
wherein the processor is configured to construct a tree-structure graph representing a dependency relationship of operations obtained from the expanded loop processing, and extract an isomorphic subgraph from the tree-structure graph.

8. The behavioral synthesis device according to claim 7,
wherein the processor is configured to turn processing of the subgraph to the function to transform the behavioral description.

9. The behavioral synthesis device according to claim 6,
wherein the processor is configured to output constraint information that constrains the part turned to the function from being expanded in the behavioral synthesis, and carry out the behavioral synthesis based on the constraint information.

10. The behavioral synthesis device according to claim 6,
wherein the processor is configured to replace a repetition part included in the part turned to the function with loop processing to transform the behavioral description.

11. A computer readable recording medium storing a behavioral synthesis program, the behavioral synthesis program causing a computer to perform operations of:
expanding loop processing included in a behavioral description;
extracting a part at which same processing is executed from an expanded loop processing;
transforming the behavioral description by turning the part to a function; and
carrying out behavioral synthesis based on a transformed behavioral description.

12. The computer readable recording medium according to claim 11,
wherein, in the extracting,
a tree-structure graph representing a dependency relationship of operations obtained from expanded the loop processing is constructed, and
an isomorphic subgraph is extracted from the tree-structure graph.

13. The computer readable recording medium according to claim 12,
wherein, in the transforming,
processing of the subgraph is turned to the function to transform the behavioral description.

14. The computer readable recording medium according to claim 11,
wherein, in the transforming,
constraint information that constrains the part turned to the function from being expanded in the behavioral synthesis is output, and the behavioral synthesis is carried out based on the constraint information.

15. The computer readable recording medium according to claim 11,
wherein a repetition part included in the part turned to the function is replaced by loop processing to transform the behavioral description.
